(19) United States
(12) Patent Application Publication
(10) Pub. No.: US 2013/0037678 A1
(43) Pub. Date: Feb. 14, 2013

(54) Shaft Device Used for Bag Hanging Device and Bag Hanging Device

(71) Applicant: Dewen Liu, Shenzhen (CN)

(72) Inventor: Dewen Liu, Shenzhen (CN)

(21) Appl. No.: 13/635,272

(22) PCT Filed: Nov. 18, 2011
(86) PCT No.: PCT/CN2011/082408

§ 371 Date: Oct. 24, 2012

(30) Foreign Application Priority Data
Dec. 28, 2010 (CN) 201020684910.3

(51) Int. Cl. F16B 45/02; F16M 13/02; F16D 3/10

(52) U.S. Cl. 248/339

(57) ABSTRACT

This utility model discloses a shaft device used for a bag hanging device and a bag hanging device that uses said shaft device. Said shaft device comprises a shaft sleeve, a shaft, a cam, a pressure wheel, and a helical compression spring. One end of the shaft sleeve is a closed end with a through hole at the center thereof, and the other end is an open end. The cam is situated at the open end of the shaft sleeve. A catching disc provided on one end of the shaft is held in the catching groove at the outer end of the cam, and the shaft successively passes through the cam and the pressure wheel and helical compression spring that are inside the shaft sleeve. The concave groove at the other end of the shaft projects out of the closed end of the shaft sleeve, and there is a catching button in said concave groove. The inside end of the cam is formed into a convex-concave shaped in the axial direction along the shaft, and the surface of the pressure wheel facing the cam is also correspondingly formed into a convex-concave shape. The helical compression spring is supported between the pressure wheel and the closed end of the sleeve. The clamping section or hook section of the bag hanging device in this utility model can maintain stability with respect to the body section after rotating a certain angle and maintain a certain clamping force between the clamping section or hook section and the body section when used as a key clasp.

### FIELD OF THE INVENTION

This utility model involves a shaft device used for a bag hanging device and a bag hanging device that uses this shaft device.

### BACKGROUND OF THE INVENTION

Because the volume of a key is rather small, a key clasp is used to link multiple keys together. However, the key clasp still has the problem of not being easy enough to be carried, and many people like to put their key clasp in a bag when they go out, and it is not easy to find when they want to use it. Current key clasps are divided into three sections: the body section, the clamping section, and the hook section, wherein the body section is an elongated metal strip, and its two ends respectively bend about 180 degrees. One end is used to hang the hook section of the key ring, and the other end is for clamping the key clasp on the clamping section on a bag or lining cloth, making it easy to find the key clasp when used. The shortcomings of the current key clasp are that there is relatively small clamping force between the metal strip of the clamping section and the metal strip of the body section, so it is easy for it to come loose when clamped on a relatively thin bag. In addition, current key clasps have only the one function of hanging keys and cannot be used as bag hanging devices. People need a multi-function bag hanging device convenient for carrying so it can be used not only as a bag hanging device, but also be placed inside a bag to act as a key clasp.

### SUMMARY OF THE UTILITY MODEL

Targeting the shortcomings of the prior art, the objective of this utility model is to provide a multi-function bag hanging device which is convenient for carrying and can be used as a key clasp.

In order to realize said objectives, this utility model has provided a shaft device for a bag hanging device, wherein it comprises a shaft sleeve, shaft, cam, pressure wheel, and helical compression spring; one end of said shaft sleeve is the closed end with a through hole at the center thereof, and the other end of said sleeve is an open end, and said cam seats at the open end of said shaft sleeve and can rotate with respect to said shaft sleeve; the inside end of said cam seats inside said shaft sleeve, and the outside end of said cam projects out of said shaft sleeve along the axis thereof, and there is a catching groove at the center of the end surface of the outside end of said cam; there is a catching disc provided on one end of said shaft, and there is a concave groove perpendicular to the axial direction of the shaft at the other end thereof; said shaft successively passes through said cam and the pressure wheel and helical compression spring seating inside said shaft sleeve; said catching disc fits inside said catching groove of said cam, and the other end of the said shaft passes through said through hole to the outside of the closed end of said shaft sleeve; there is a catching button provided in the catching groove to restrict the axial movement of said shaft; said pressure wheel is sleeved on the inner wall of said shaft sleeve and rotates synchronously with said shaft sleeve; it can also move axially along said shaft sleeve, and a concave-convex shape in the axial direction along said shaft is formed at the inside end of said cam, a concave-convex shape is also correspondingly formed at the surface of said pressure wheel facing said cam; said helical compression spring rests between the pressure wheel and the closed end of the sleeve.

This utility model also has provided a bag hanging device, which comprises a body section and a clamping section, wherein one end of said body section rotatably connects with said clamping section by said shaft device used for the bag hanging device, and wherein the outer housing of said shaft sleeve is inserted into said body section; a first stopping piece is provided at the end of the body section connecting with said clamping section to limit the rotation angle of said clamping section; the outside end of said cam is inserted into said clamping section, and the free end of said clamping section rests on said body section.

Furthermore, said bag hanging device also includes a hook section, the other end of the body section is rotatably connected to the hook section through said shaft device used for the bag hanging device, wherein the outside housing of said shaft sleeve is inserted into said hook, and a second stopping piece for limiting the rotation angle of said hook section is provided at one end of the hook section connecting to said body section; the outside end of said cam is inserted into said body section, and the free end of said hook section rests on said body section.

Preferably, said hook section and said clamping section are respectively located at the two sides of said body section.

Preferably, the end of said body section connecting with said hook section is bent to the side of said body section connecting with said clamping section.

Preferably, there is a clamping disc at the free end of said clamping section.

Furthermore, as a preferable option, said clamping disc is round, rectangular, oval, or heart shaped. Further, as a preferable option, said clamping disc is further provided with a LED light.

The shaft device used for the bag hanging device in this utility model can rotatably connects the clamping section or hook section to the body section and maintains a certain clamping force with the body section. In addition, the clamping section or hook section is maintained in a stable condition after rotating to a certain angle relative to the body section. The clamping section and the hook section of the bag hanging device according to said utility model each can be maintained in a stable condition after rotating to a certain angle relative to the body section. The hook section can be used to hang a bag or other object when the clamping section is placed on top of a table. When the clamping section and the hook section of the bag hanging device in this utility model are clamped together with the body section, it can also be used as a key clasp.

### BRIEF DESCRIPTION OF THE DRAWINGS

FIG. 1 is the front view of the shaft device used for the bag hanging device in accordance with an example of this utility model;

FIG. 2 is a schematic section view of FIG. 1 along the A-A line;

FIG. 3 is an enlarged perspective exploded schematic view of FIG. 1;

FIG. 4 is a schematic view of FIG. 3 in another direction;

FIG. 5 is a perspective structural schematic view of the bag hanging device (when the clamping section is closed) in accordance with the example of this utility model;

FIG. 6 is the front view of FIG. 5;

FIG. 7 is a right-side view of FIG. 5;

FIG. 8 is an exploded schematic view of the bag hanging device and the shaft device in accordance with the example of this utility model;

FIG. 9 is a perspective structural schematic view of the bag hanging device (when the clamping section is open) in accordance with the example of this utility model.

FIG. 10 is a schematic view showing the in-use condition of hanging a key of the bag hanging device shown in FIG. 7.

FIG. 11 is a schematic view showing the in-use condition of hanging a bag of the bag hanging device shown in FIG. 9.

FIG. 12 is a perspective structural schematic view of a bag hanging device (with a LED light on the clamping disc) in accordance with another example of this utility model.

### DETAILED DESCRIPTION ON THE EMBODIMENTS

The following refers to the embodiments of this utility model described in detail in reference to the accompanying Figures.

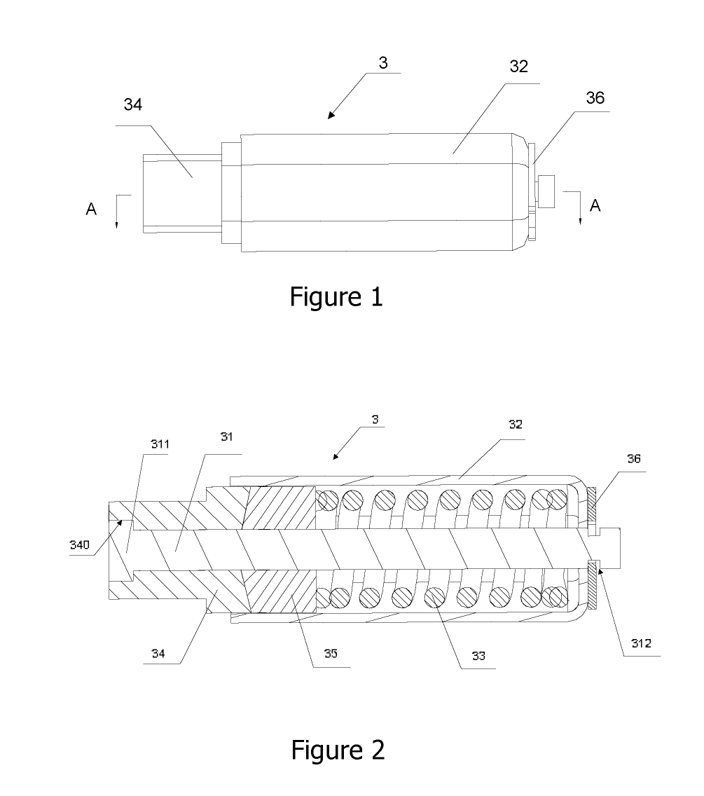

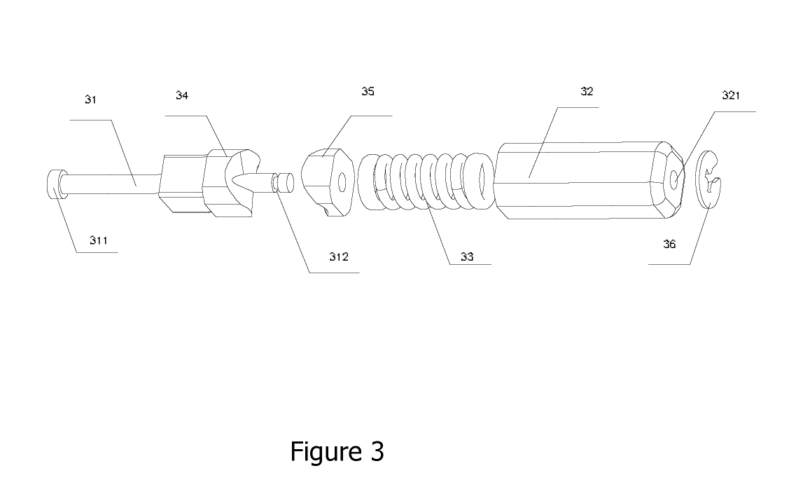

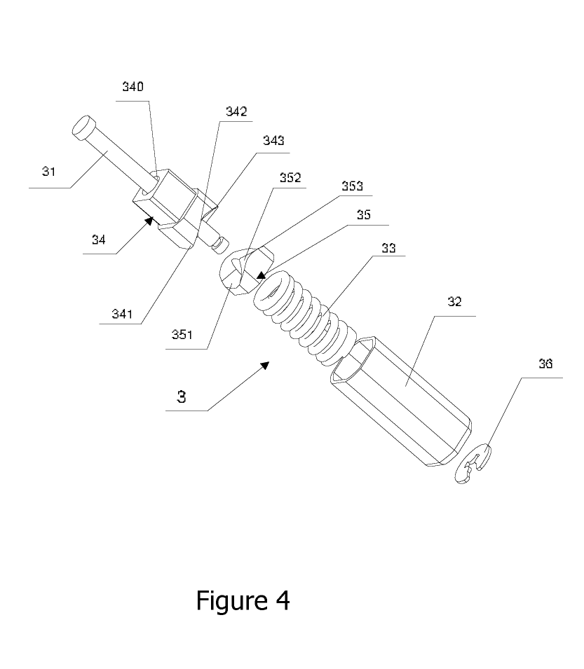

FIG. 1 is the front view of the shaft device used for the bag hanging device in accordance with an example of this utility model; FIG. 2 is a schematic section view of FIG. 1 along the A-A line; FIG. 3 is an enlarged perspective exploded schematic view of FIG. 1; FIG. 4 is a schematic view of FIG. 3 in another direction.

As shown in FIG. 1-FIG. 4, the shaft device 3 in accordance with the example in this utility model comprises a shaft 31, a shaft sleeve 32, a cam 34, a pressure wheel 35, and a helical compression spring 33; one end of the shaft sleeve 32 is the closed end, wherein a through hole 321 is provided at its center, and the other end of shaft sleeve 32 is the open end, and cam 34 is situated at the open end of shaft sleeve 32; the inside end of cam 34 is situated inside the shaft sleeve 32, and the outer end of cam 34 projects out of the shaft sleeve 32 along the axial direction of the shaft 31; the center of surface of the outer end of the cam 34 has a catching groove 340, and the cam 34 can rotate relative to shaft sleeve 32; one end of the shaft 31 has a catching disc 311, and the other end of the shaft 31 has a concave groove 312 that is perpendicular to the axial direction of it; the shaft 31 successively passes through the cam 34 and the pressure wheel 35 and helical compression spring 33 seated inside the shaft sleeve 32; the catching disc 311 that is at one end of the shaft 31 is held inside the catching groove 340 of the cam 34, and the other end of the shaft 31 passes through the through hole 321 and extends out of the closed end of the shaft sleeve 32; A catching button 36 is provided in the concave groove 312 on shaft 31 to limit the movement of shaft 31 along its axial direction. The surface of the pressure wheel 35 is of a polygonal prism shape, the inner wall of shaft sleeve 32 is also of a polygonal prism shape, and the pressure wheel 35 is encased on the inner wall of the shaft sleeve 32, thereby enabling the pressure wheel 35 and the shaft sleeve 32 to rotate synchronously, and the pressure wheel 35 can move axially along the shaft sleeve 32. The inside end of the cam 34 is formed into a concave-convex shape in the axial direction of shaft 31. The surface of the pressure wheel 35 facing the cam 34 is also correspondingly formed into a concave-convex shape, and the helical compression spring 33 rests between the pressure wheel 35 and the closed end of the shaft sleeve 32. The inside end of cam 34 and the side surface of the pressure wheel 35 both are of a polygonal prism shape, and the radial dimension of the inside end of the cam 34 is less than that of the shaft sleeve 32. The cam 34 can rotate relative to the shaft sleeve 32, and the outer surface of the part of the outside end of the cam 34 that protrudes from the shaft sleeve 32 is of a polygonal prism shape and used to nest with one of the rotating components. The outside housing of shaft sleeve 32 is also of a polygonal prism shape and nests with another rotating component.

As shown in FIG. 2 and FIG. 4, in the shaft device 3 of this utility model, because the shaft 31 presses the cam 34 onto the pressure wheel 35 through the catching disc 311 and concave groove 312 at each end thereof, the helical compression spring 33 exerts axial pressure along the shaft 31 on the pressure wheel 35, thereby causing the concave-convex section of the inner side of cam 34 and the convex-concave section on the pressure wheel 35 to press each other. As shown in FIG. 4, two convex sections 341 and 343 in the axial direction along the shaft 31 are provided on the cam 34 in this implementation example, and a concave section 342 is provided between convex sections 341 and 343 (with another one on the other side, not shown in the Figure); similarly, there are corresponding concave sections 351 and 353 on the pressure wheel 35, and between concave section 351 and concave section 353 are convex section 352 and convex section 354. In the initial status, convex section 341 on cam 34 and concave section 351 on pressure wheel 35 are matched, and concave section 342 on cam 34 and convex section 352 on pressure wheel 35 are matched. Because of the effect of the helical compression spring 33, the pressure wheel 35 and cam 34 maintain a certain pressure in the axial direction of shaft 31, thereby enabling the stable condition between the cam 34 and the shaft sleeve 32 and requiring the exertion of certain amount of external force in order to rotate the cam 34.

As shown in the schematic view of FIG. 4, exertion of a certain amount of external force rotates the cam 34 in a counter-clockwise direction, enabling the rotation of the cam 34 relative to the shaft sleeve 32, the convex section 341 of cam 34 and the convex section 352 of the pressure wheel 35 will press each other, and the cam 34 presses the pressure wheel 35 to the inside of the shaft sleeve 32, thereby further pressing the helical compression spring 33. When the cam 34 rotates to a certain angle a relative to the shaft sleeve 32, the convex section 341 of the cam 34 then enters into the concave section 353 of the pressure wheel 35, thereby the convex sections of the cam 34 and the concave sections of the pressure wheel 35 are again correspondingly matched, and a new stable condition is maintained under the effect of the helical compression spring 33. As can be seen from the above analysis, the shaft device 3 can be maintained in a stable condition as long as the cam 34 rotates a certain angle a. The size of a is determined by the size of the corresponding central angle projected by the convex section and concave section on cam 34 and pressure wheel 35 in the axial direction of shaft 31. It must be understood that, in this implementation example, the cam 34 with only two convex sections is used as an example for illustration. If cam 34 has more convex sections and concave sections over its circumference, and pressure wheel 35 also has concave sections and convex sections that correspond with cam 34, then cam 34 can be maintained in a stable condition for many times after rotating a certain angle relative to shaft sleeve 32.

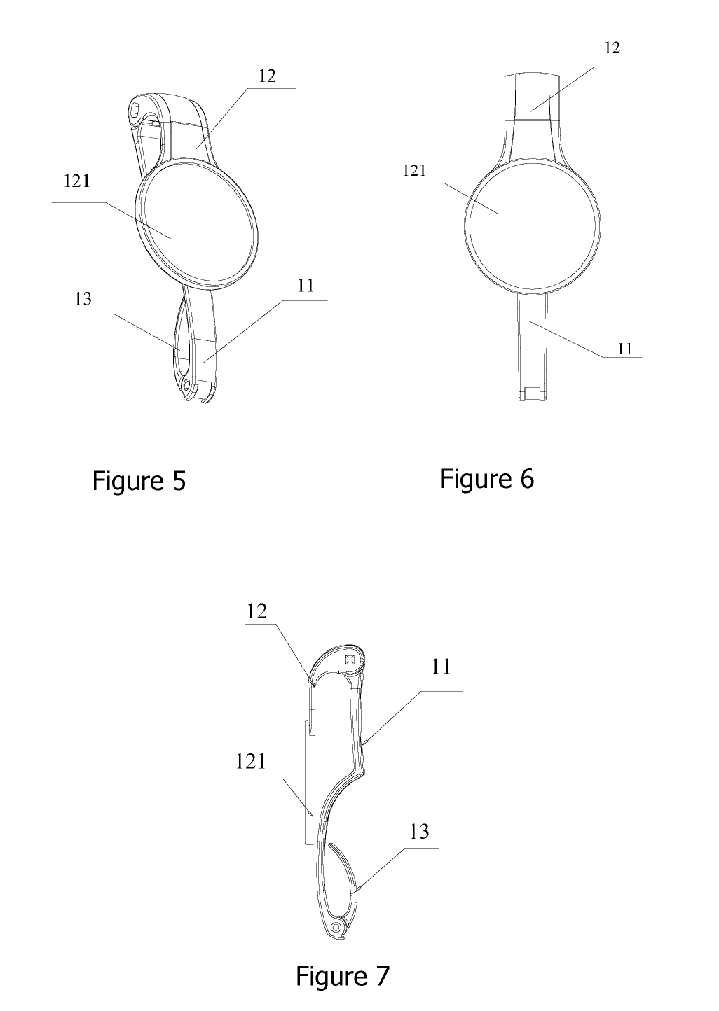

FIG. 5 is a perspective structural view of the bag hanging device (when the clamping section is closed) in the implementation examples for this utility model; FIG. 6 is the front view of FIG. 5; FIG. 7 is the right-hand view of FIG. 5.

As shown in FIG. 5 through FIG. 7, the bag hanging device in the implementation examples for this utility model comprises the body section 11, the clamping section 12, and the hook section 13, and the two ends of the body section 11 are respectively rotatably connected with the clamping section 12 and hook section 13 by the shaft device 3 described above. The bag hanging device in this implementation example can act as a bag hanging device as well as a key clasp.

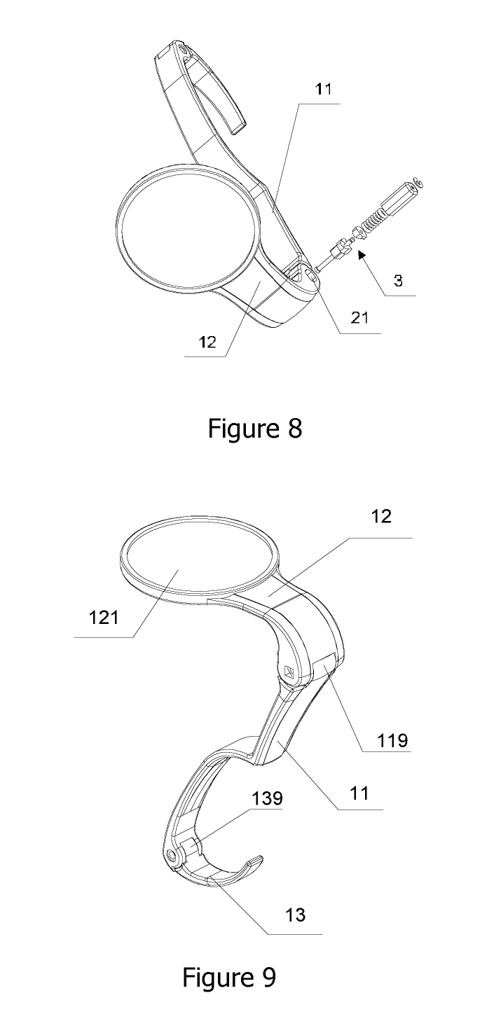

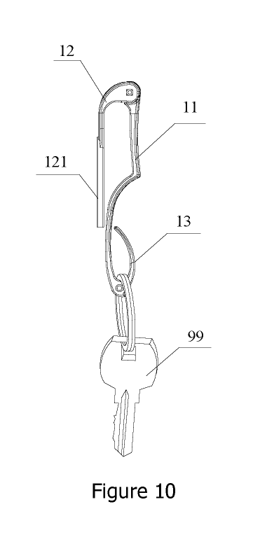

As shown in FIG. 5 through FIG. 7 and FIG. 10, when the bag hanging device in this implementation example is used as a key clasp, the clamping section 12 and bent section 13 are kept closed. Under the effect of the helical compression spring inside the shaft device 3, the free end of the clamping section 12 rests on the body section 11, and the free end of the hook section 13 also rests on the body section 11. FIG. 8 is an exploded schematic view of the bag hanging device and the shaft device in the implementation examples of this utility model. As shown in FIG. 8, the connection portion between the body section 11 and the clamping section 12 has a connection hole 21, and shaft device 3 is situated inside the connection hole 21. The outside housing of the shaft sleeve of shaft device 3 is inserted into the body section 11, and the outside end of the cam of the shaft device 3 is inserted into clamping section 12. A similar method is used to connect the body section 11 with hook section 13, which will not be repeated in details here. Because the shaft device 3 connection described above is used, when the utility model is used as a key clasp, the cam inside connection hole 21 maintains stability relative to the shaft sleeve, thereby ensuring that stability is maintained between the clamping section 12 inserted into the cam and the body section 11 inserted into the shaft sleeve. A certain amount of external force is needed to rotate the clamping section 12. As shown in FIG. 10, when the bag hanging device in accordance with the example is used as a key clasp, the hook section 13 is closed, a key 99 is hanging between the hook section 13 and the body section 11, meanwhile the clamping section 12 is also closed, then the clamping section 12 can be inserted to the outer skin of the bag, so as to facilitate key finding.

Preferably, as shown in FIG. 5 through FIG. 7, in this implementation example, the clamping section 12 and the bending section 13 are situated at the two sides of the body section 11, and in order to increase the clamping force of the clamping section 12 and the body section 11, one end of the body section 11 connecting with the hook section 13 is bent towards the side with the clamping section 12 so that the clamping section 12 can more tightly rest on the body section 11. Preferably, in this implementation example, there is a clamping disc 121 on the free end of the clamping section 12, and the clamping disc 121 can provide a larger contact surface area. In this implementation example, the shape of the clamping disc 121 is round, and of course the shape of the clamping disc 121 can also be rectangular, oval, or heart shaped. The clamping disc 121 has a larger surface area and can increase the friction between the clamping section 121 and the object being clamped. When used as a bag hanging device, the clamping disc 121 is placed on a table surface and can increase the friction with the table surface and maintain the stability of the bag hanging device.

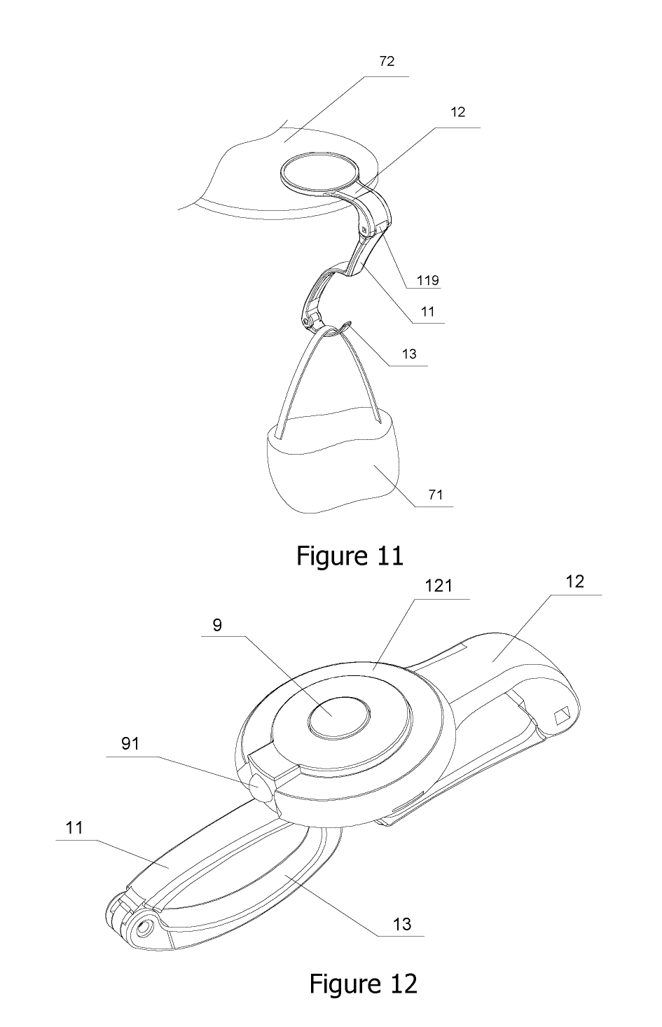

FIG. 9 is a perspective structural schematic view of the bag hanging device (when the clamping section is open) in the implementation examples of this utility model. As shown in FIG. 9 and FIG. 11, it is a condition where the bag hanging device in this utility model is used as a bag hanging device, because the cam in the above described shaft device can maintain stability after rotating a certain angle relative to the shaft sleeve, the clamping section 12 connected to the cam in an insertion manner can also maintain stability after rotating a certain angle relative to the body section connected with the shaft sleeve in an insertion manner. A bag or other object can be hung on the hook section 13, and when the clamping disc 121 on the clamping section 12 is placed on a table surface, it can also be used as a bag hanging device. The bag hanging device in this implementation example has the advantages of convenient carrying and usage.

The connection between the body section 11 and the clamping section 12 and hook section 13 for the bag hanging device in this implementation example uses the shaft device 3 described above. Because of the effect of the cam with the pressure wheel and helical compression spring in the shaft device 3, when being used as a key clasp, the clamping section 12 and hook section 13 both rest on the body section 11 and can maintain a certain clamping force. A certain clamping force needs to be exerted in order to be able to rotate them. When being used as a bag hanging device, the clamping section 12 and the bending section 13 can both maintain stability after rotating to a certain angle relative to the body section 11, and they can bear a certain external force.

As shown in FIG. 9, one end of the body section 11 which connects to the clamping section 12 is provided with a first stopping piece 119 used to limit the rotation angle of the clamping section 12 and to prevent an excessive rotation angle of clamping section 12 relative to the body section 11. One end of the hook section 13 which connects to the body section 11 is provided with a second stopping piece 139 used to limit the rotation angle of the hook section 13 and to prevent an excessive rotation angle of hook section 13 relative to the body section 11. As shown in FIG. 12, another embodiment of the bag hanging device in accordance with this utility model, a LED light 9 is provided on the clamping disc 121, wherein the power source of the LED light 9 can be a button cell, and locate inside the clamping disc 121, the switch 91 for the LED light 9 is located on the side of the clamping disc 121.

Of course, the above are preferred embodiments for the utility model. It should be noted that, for one skilled in the art, some modifications and variants can be made without departing from the principles of this utility model, and these modifications and variants are also included in the protected scope of this utility model.

What is claimed is:

1. A shaft device used for a bag hanging device, characterized in that, said shaft device comprises a shaft sleeve, a shaft, a cam, a pressure wheel, and a helical compression spring; one end of said shaft sleeve being a closed end with a through hole at the center thereof, and the other end of said shaft sleeve being an open end, and said cam situated at the open end of said shaft sleeve and rotatable relative to said shaft sleeve;
the inside end of said cam situated inside said shaft sleeve, and the outside end of said cam projecting out of said shaft sleeve along the axial direction of said shaft sleeve, and a catching groove provided on the center of the end surface of the outside end of said cam;
a catching disc provided on one end of said shaft, and a concave groove perpendicular to the axial direction of the shaft provided at the other end of the shaft; said shaft successively passing through said cam and the pressure wheel and the helical compression spring inside said shaft sleeve; said catching disc held inside said catching groove of said cam, and the other end of the said shaft extending through said through hole to the outside of the closed end of said shaft sleeve; a catching button provided in said concave groove to limit the movement of said shaft along the axial direction thereof;
said pressure wheel nested in the inner wall of said shaft sleeve, rotating synchronously with said shaft sleeve and movable axially along said shaft sleeve, a concave-convex shape in the axial direction along said shaft formed at the inside end of said cam, a concave-convex shape correspondingly formed on a surface of said pressure wheel facing said cam; said helical compression spring resting between the pressure wheel and the closed end of the sleeve.

2. A bag hanging device, comprising a body section and a clamping section, characterized in that one end of said body section rotatably connects with said clamping section by the shaft device used for said bag hanging device according to claim 1, and wherein the outer housing of said shaft sleeve is connected to said body section in an insertion manner; a first stopping piece is provided at one end of the body section which connects to said clamping section to limit the rotation angle of said clamping section; the outside end of said cam is connected to said clamping section in an insertion manner, and the free end of said clamping section rests on said body section.

3. The bag hanging device according to claim 2, further comprising a hook section, and the other end of said body section rotatably connecting to said hook section through the shaft device according to claim 1, wherein the outer housing of said shaft sleeve is connected to said hook section in an insertion manner, and a second stopping piece is provided at the end of said hook section which connects to said body section to limit the rotation angle of said hook section; the outside end of said cam is connected with the said body section in an insertion manner, and the free end of said hook section rests on said body section.

4. Said bag hanging device according to claim 2, characterized in that said hook section and said clamping section are respectively located at the two sides of said body section.

5. Said bag hanging device according to claim 4, characterized in that the end of said body section which connects to said hook section is bent to the side connecting with said clamping section.

6. Said bag hanging device according to claim 2, characterized in that there is a clamping disc provided at the free end of said clamping section.

7. Said bag hanging device according to claim 6, characterized in that said clamping disc is round, rectangular, oval, or heart shaped.

8. Said bag hanging device according to claim 6, characterized in that said clamping disc is further provided with a LED light.
